(19) United States
(12) Patent Application Publication
(10) Pub. No.: US 2007/0085441 A1
(43) Pub. Date: Apr. 19, 2007

(54) Iron core for rotary electric machinery and its assembly method

(75) Inventor: Huo Kao, Teipei City (TW)

Correspondence Address: BUCKNAM AND ARCHER, 1077 NORTHERN BOULEVARD, ROSLYN, NY, 11576, US

(73) Assignee: Chuan Yao Machinery & Electric Corp., Chungli City (TW)

(21) Appl. No.: 11/364,903

(22) Filed: Feb. 27, 2006

(30) Foreign Application Priority Data
Oct. 18, 2005 (TW) 094136314

(51) Int. Cl. H02K 1/28; H02K 1/12

(52) U.S. Cl. 310/218; 29/596; 310/259

(57) ABSTRACT

An iron core for rotary electric machinery and a method of assembling the same are disclosed. The method involves preparing a plurality of arch-shaped iron core plates and overlapping the plurality of arch-shaped iron core plates to form a lamination unit having a predetermined thickness; forming an annular member with several lamination units in the same group, by abutting the side portions of each lamination unit against the side portions of adjacent lamination units of the same group; overlapping a plurality of at least three layers of annular members in such a manner that the abutting junctions between the adjacent lamination units of one annular member is staggered a certain angle from the abutting junction between the lamination units of another annular member in proximity layer, so as to form a mutually restricted and mechanically enhanced structure; inserting fastening bolts into through holes aligned vertically in the plurality of annular members to tighten them firmly together.

### BACKGROUND OF THE INVENTION

1. Field of the Invention

The present invention relates to an iron core for rotary electric machinery, and more particularly to the assembly method of an iron core formed by a plurality of annular members, each including several lamination units abutted against one another, each lamination unit being formed by overlapping a plurality of iron core plates.

2. Description of the Related Art

Conventionally, an iron core for rotary electric machinery such as stator, external rotor or internal rotor, as shown in FIG. 7, is comprised of a plurality of annular silicon steel plates (indicated by reference sign \textcircled{3} in FIG. 7) arranged in a lamination. The annular silicon steel plates are stamped from flat silicon steel plates. The fabrication of such annular silicon steel plates wastes much silicon steel material (see the crosshatched areas indicated by reference signs \textcircled{1} and \textcircled{2} in FIG. 7). More particularly, when making a big scale external rotor, about one half of the silicon steel material is wasted, resulting in a high manufacturing cost.

FIGS. 8 and 9 show another structure of iron core constructed according to Taiwan Patent No. 1234917, which is designed to eliminate the aforesaid waste material problem. According to this design, the iron core (1′) comprises a plurality of core members (2′) radially coupled together. Each core member (2′) comprises a plurality of first plate-like core elements (6′) and a plurality of second plate-like core elements (10′). Each first plate-like core element (6′). has a sector portion (3′) at one end and a base (5′) of a predetermined shape at the other end. Each second plate-like core element (10′) has a sector portion (3′) at one end and a coupling portion (9′) at the other end that forms a yoke (8′). The coupling portion (9′) has a through hole (7′). The first plate-like core elements (6′) and second plate-like core elements (10′) of the core members (2′) are so arranged that the coupling portions (9′) of the second plate-like core elements (10′) of one core member (2′) are abutted against the bases (5′) of the first plate-like core elements (6′) of another core member (2′), and the coupling portions (9′) of the core members (2′) are arranged in a lamination with the respective through holes (7′) aligned in line.

The aforesaid iron core that is formed by radially coupling a plurality of core members together reduces the scrap of waste material. However, because the precision requirement of the first and second plate-like core elements is critical, the precision of the related manufacturing equipment is also critical and a relatively higher technical level is required.

### SUMMARY OF THE INVENTION

The present invention has been accomplished under the circumstances in view. It is the main object of the present invention to provide an iron core and its assembly method, which avoids much material waste and reduces the iron core manufacturing cost.

To achieve this and other objects of the present invention, the iron core assembly method comprises the steps of:
(a) preparing a plurality of arch-shaped iron core plates with certain radii on both outer and inner arcs, each arch-shaped iron core plate having a plurality of coil(wire) slots along one side of the outer and inner circumferences of the core plate, and a plurality of welding recesses along the other side of the outer and inner circumferences of the core plate, and a plurality of through holes for positioning provided on the end face;
(b) overlapping the arch-shaped iron core plates to form a lamination unit having a predetermined thickness,
(c) forming an annular member with several lamination units, defined as the same group, by abutting the side portions of each lamination unit against the side portions of the adjacent lamination units of the same group;
(d) overlapping a plurality of said annular members in such a manner that the abutting junctions between the lamination units of one annular member is staggered a certain angle from the abutting junctions between the lamination units of the adjacent annular member in the upper or lower layer of the overlapped structure;
(e) inserting fastening screw bolts into the through holes for positioning, aligned vertically in said plurality of annular members, for tightening said plurality of annular members firmly together,
(f) alternatively, welding along the lines formed by the welding recesses of each core plate so as to form an integral iron core.

Specifically, the iron core according to the present invention is a 120° sector member, which can optimally use raw material so as to achieve optimum layout on the silicone steel plate with least waste scrap happened in the stamping process. Furthermore, the abutting junction J between the lamination units of one annular member is equally spaced, and is staggered 40° from the abutting junctions J between the lamination units of another adjacent annular member. Even the staggering of junction exist, the through holes for positioning can be aligned vertically with the adjacent layer of annular members, so that fastening bolts can be inserted through the hole for fixing. Furthermore, TIG welding is performed along the welding recess lines formed by the welding recess on each arch-shaped iron core plate. In this way, the iron core thus produced not only saves material but also has enough strength.

### BRIEF DESCRIPTION OF THE DRAWINGS

FIG. 1 is a schematic plain view of an arch-shaped iron core plate for iron core according to the present invention.

FIG. 2 is a schematic drawing showing three arch-shaped iron core plates formed from one silicon steel plate according to the present invention.

FIG. 3 is an exploded view of an iron core constructed according to the present invention.

FIG. 4 is an elevational assembly view of the iron core shown in FIG. 3.

FIG. 5 is a schematic top plain view of the iron core according to the present invention.

FIG. 5a is an enlarged view of part 5a of FIG. 5.

FIG. 6 is a schematic drawing showing the portion of waste material in a silicon steel plate according to the present invention.

FIG. 7 is a schematic drawing showing the portion of waste material in a silicon steel plate according to the prior art technique.

FIG. 8 is an elevational view of another structure of iron core according to the prior art.

FIG. 9 is an exploded view of the iron core shown in FIG. 8.

### DETAILED DESCRIPTION OF THE PREFERRED EMBODIMENT

The invention relates to the iron core for rotary electric machinery such as stator, external rotor, or internal rotor. The spirit and features of the prevent invention will be described by way of a preferred embodiment. However, it is to be understood that the embodiment hereinafter described is for purposes of illustration only, not for limitative purpose.

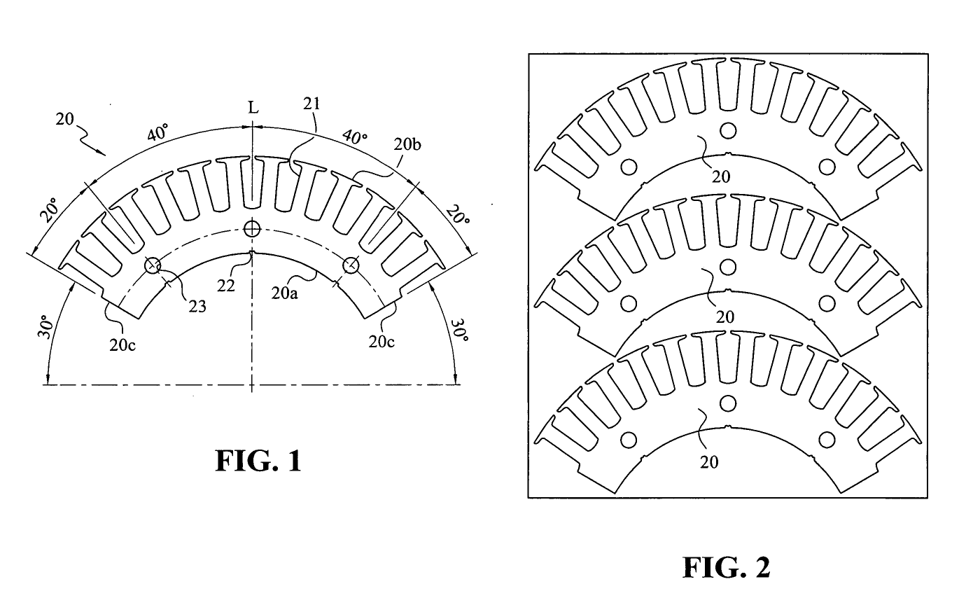

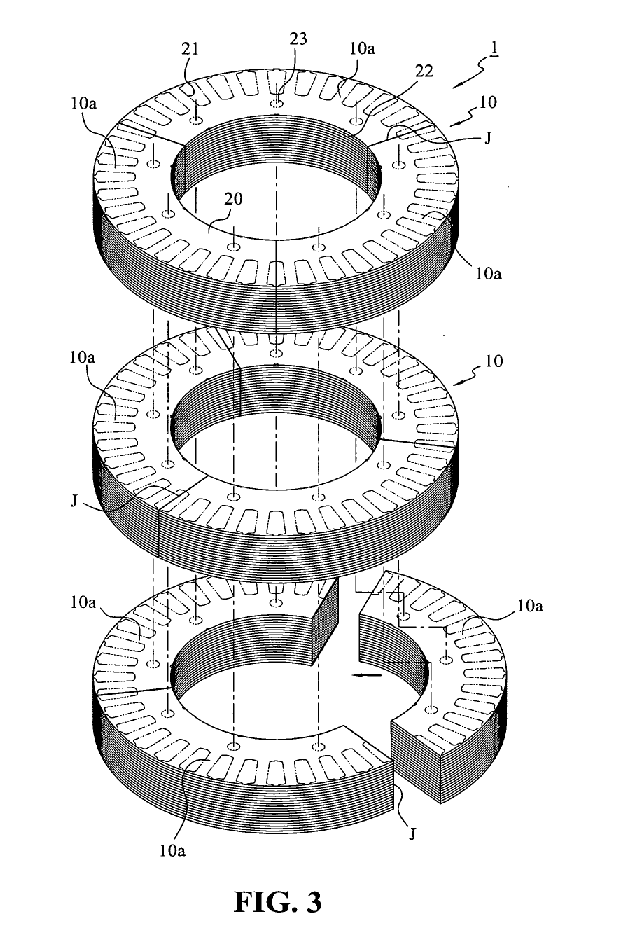

Referring to FIGS. 1 through 4, the assembly method of an iron core 1 in accordance with the present invention comprises the steps of:
(1) preparing a plurality of arch-shaped iron core plates 20, having certain radii on both the outer and inner arcs, which are stamped from steel plates raw material (see FIG. 1), each arch-shaped iron core plate 20 having a plurality of coil (wire) slots 21 spaced along the outer circumference of the plate, a plurality of welding recesses 22 spaced along the inner circumference edge, and a plurality of through holes 23 for positioning respectively disposed corresponding to the welding recesses 22. As shown in FIG. 2, this type of iron core plate are usually produced by successive stamping process with conventional stamping equipment.
(2) overlapping a plurality of arch-shaped iron core plates 20 to form a lamination unit 10a having a predetermined thickness,
(3) forming an annular member 10 with several lamination units 10a, defined as the same group, by abutting the side portions of each lamination unit 10a against the ends of the adjacent lamination units 10a of the same group (see FIG. 3),
(4) overlapping a plurality of above annular member 10 in such a manner that the abutting junction J of one annular member 10 is deviated a certain angle from the abutting junction J of another annular member 10 on different layer of the overlapping structure,
(5) inserting fastening bolts (not shown in Figs.) into the through holes 23 for positioning, which are aligned vertically through each of said plurality of annular members 10, so as to tighten the plurality of annular members 10 firmly together (as shown in FIG. 4).
(6) alternatively, welding along the lines formed by the welding recesses 22 of each annular members 10 so as to form an integral iron core.

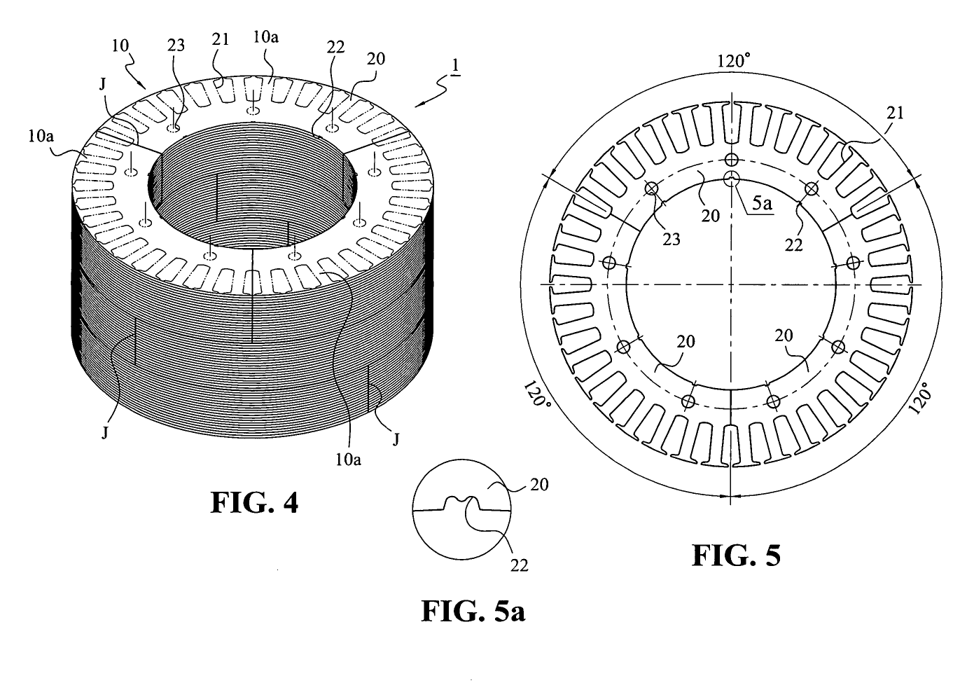

Referring to FIG. 1 and FIG. 5, each annular member 10 is formed by the end-to-end abutting of the side portions of at least three lamination unit 10a. Preferably, each annular member 10 is formed of three lamination unit 10a made by the overlap of iron core plates 20. According to this embodiment, each annular member 10 is formed of three lamination unit 10a made by the overlap of iron core plates 20, i.e., each iron core plate 20 is a 120° sector member. This design utilizes optimally the steel plate raw material, which results in the reducing of scraps of material (as shown in FIG. 2). Further, the coil slots 21 may be arranged along the outer diameter edge area 20b or inner diameter edge area 20a of the iron core plate 20, which is determined by the design of the iron core, i.e., the stator, external rotor or internal rotor. Further, each iron core plate 20 has at least three through holes 23 for positioning. According to this embodiment, each iron core plate 20 has three through holes 23 for positioning that are spaced from one another at 40°. The centerline L of each through hole 23 is in coincidence with the center of one corresponding welding recess 23.

Further, the abutted junctions J between two adjacent lamination units 10a of one annular member 10 are staggered 40°, from the abutted junctions J between two adjacent lamination units 10a of another annular member 10 on different layer of the overlapped structure, i.e., the deviation is equal to the pitch between two through holes 23 for positioning. Therefore, the abutted junctions J between two adjacent lamination units 10a of one annular member 10 are equally spaced and are deviated from the abutted junctions J between two adjacent lamination units 10a of another annular member 10. When the annular members 10 are arranged in a lamination, screw bolts can be inserted into the through holes 23 for positioning, which are respectively aligned in vertical direction. Alternatively, the welding recesses 22 are respectively vertically welded together by TIG welding. In this case, positioning pins (not shown) can be inserted into the through holes for positioning and retreated from the through holes after the completion of welding. This iron core assembly method saves material consumption and, assures a high structural strength.

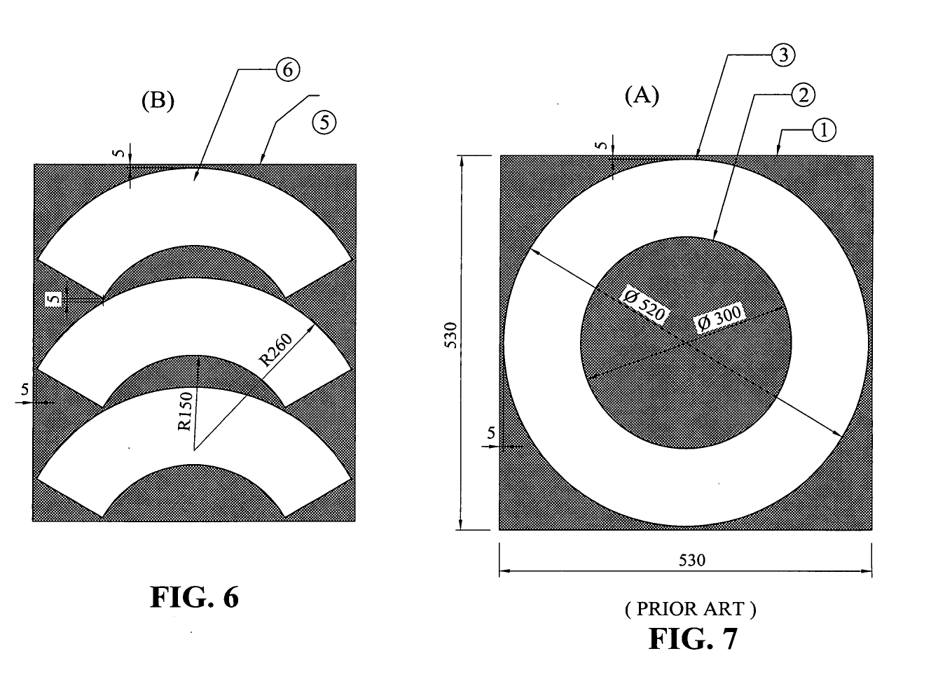

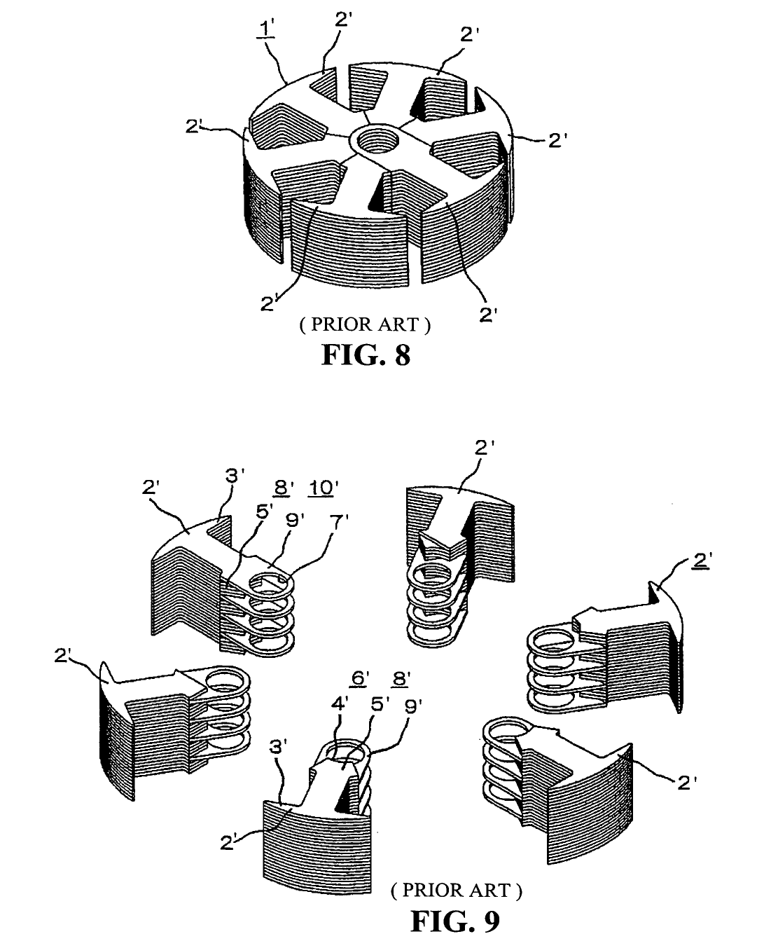

The advantage of the present invention in saving the consumption of material will be fully understood by comparing FIG. 6 to the prior art FIG. 7. FIG. 6 shows the technique of the present invention (B) where the crosshatched area indicates the scrap material. FIG. 7 shows the technique of the prior art (A) where the crosshatched area indicates the scrap material. When comparing an iron core of outer diameter φ520 and inner diameter φ300 made according to the present invention to an iron core of outer diameter φ520 and inner diameter φ300 made according to the prior art, thus:

(A) Area of silicon steel plate material: \textcircled{1}280900;

Area of φ520: \textcircled{3}212371.66;

Area of φ300: \textcircled{2}70685.83

Scrap: \textcircled{1}−\textcircled{3}+\textcircled{2}=139214.17;

Scrap rate=Scrap/Total area=139214.17/280900=about 49.5%

(B) Area of silicon steel plate material: \textcircled{5}232672,76;

Area of arch-shaped iron core plates:
\textcircled{6}47228.16×3=141685.83;

Scrap: \textcircled{5}−\textcircled{6}=90986.93;

Scrap rate=Scrap/Total area=90986.93/232672.76=about 39.1%.

According to the aforesaid calculation, the scrap rate of the prior art design (A) is about 21% higher than the present invention (B).

Although a particular embodiment of the invention has been described in detail for purposes of illustration, various modifications and enhancements may be made without departing from the spirit and scope of the invention. Accordingly, the invention is not to be limited except as by the appended claims.

### LIST OF REFERENCE NUMBERALS

1 iron core of the present invention
10 annular member
10a lamination unit
20 arch-shaped iron core plate
20a inner circumference edge of iron core plate
20b outer circumference edge of iron core plate
20c distal sides of iron core plate
21 coil slot
22 welding recess
23 through hole for positioning
J abutting juction
L centerline of through hole

What the invention claimed is:

1. An iron core (1) assembly method comprising the steps of:
(1) preparing a plurality of arch-shaped iron core plates (20) with certain radii on both outer and inner arcs, each arch-shaped iron core plate (20) forming a plurality of coil slots (21) along one side of the outer and inner circumferences, a plurality of welding recesses (22) along the other side of the outer and inner circumferences, and a plurality of through holes (23) respectively provided on fixed point of the end face;
(2) overlapping said plurality of arch-shaped iron core plates (20) to form a lamination unit (10a) with a predetermined thickness;
(3) forming an annular member with several lamination units (10a), defined as the same group, by abutting the side portions of each lamination unit (10a) against the side portions of the adjacent lamination units (10a) of the same group;
(4) overlapping a plurality of annular members 10 to form an overlapped structure in such a manner that each abutting junction (J) between the end portions of adjacent lamination units (10a) of one annular member (10) is staggered a certain angle from the corresponding abutting junction (J) between the end portions of adjacent lamination units (10a) of another annular member (10) in proximity layer of the overlapped structure;
(5) inserting fastening bolts respectively into the corresponding through holes (23), which are aligned vertically in each annular member (10) of the overlapped structure, for tightening the annular members (10) of the overlapped structure firmly together;
(6) alternatively, welding along the lines thus formed after the formation of said overlapped structure of annular members (10), by the welding recesses (22) of each annular member (10) so as to form an integral iron core.

2. An iron core (1) assembly method as claimed in claim 1, wherein each annular member (10) is formed by at least 3 lamination units (10a).

3. An iron core (1) assembly method as claimed in claim 2, wherein each arch-shaped iron core plate (20) is a 120° sector member.

4. An iron core (1) assembly method as claimed in claim 3, wherein each arch-shaped iron core plate (20) has at least 3 through holes (23) for positioning.

5. An iron core (1) assembly method as claimed in claim 4, wherein each arch-shaped iron core plate (20) has two distal sides (20c), each of which forms an angle of 20° with the centerline of the respective adjacent through hole (23).

6. An iron core (1) assembly method as claimed in claim 5, wherein the through holes (23) of each arch-shaped iron core plate (20) is spaced from one another at 40°.

7. An iron core (1) assembly method as claimed in claim 6, wherein each welding recess (22) of each arch-shaped iron core plate (20) is aligned with a corresponding through hole (23) along the center line (L) of that through hole (23).

8. An iron core (1) assembly method as claimed in claim 6, wherein the abutted junctions (J) between the adjacent lamination units (10a) of one annular member (10) is staggered 40° from the abutting junctions (J) between the adjacent lamination units (10a) of another annular member (10) in proximity layer of the same overlapped structure.

9. An iron core (1) assembly method as claimed in claim 6, wherein the coil slots (21) of each arch-shaped iron core plate (20) are equally spaced along the outer diameter edge area of the respective arch-shaped iron core plate (20).

10. An iron core (1) assembly method as claimed in claim 6, wherein the coil slots (21) of each arch-shaped iron core plate (20) are equally spaced along the inner diameter edge area of the respective arch-shaped iron core plate (20).

11. An iron core (1) for rotary electric machinery, characterized in that:
(a) said iron core (1) comprises a plurality of annular members (10) overlapped in vertical direction, each annular members (10) having a plurality of lamination units (10a) in end-to-end abutted relationship against one another to form an abutted junctions (J) between the adjacent lamination units (10a), which are staggered respectively certain angle from the corresponding abutted junctions (J) between the adjacent lamination units (10a) of another annular member (10) in proximity layer of the overlapped structure;
(b) each of said lamination units (10a) is formed by a plurality of arch-shaped iron core plates (20) overlapped together to form a predetermined thickness;
(c) each arch-shaped iron core plate (20) has an inner diameter edge (20a), an outer diameter edge area (20b), a plurality of coil slots (21) arranged along one side of said inner diameter edge area (20a) and said outer diameter edge area (20b), a plurality of welding recesses (22) arranged along the other side of said inner diameter edge area (20a) and said outer diameter edge area (20b), and a plurality of through holes (23) for positioning provided at fixed points on the end face of said core plate (20);
(d) the overlapped structure of said plurality of annular member (10) are fixed either by the insertion of a plurality of fastening bolts into the through holes (23) for tightening said plurality of annular member (10) together, or by the welding performed along the welding lines formed by the welding recesses (22) of each arch-shaped core plate (20) so as to form an integral iron core (1).

12. An iron core (1) as claimed in claim 11, wherein each arch-shaped iron core plate (20) is a 120° sector member.

13. An iron core (1) as claimed in claim 12, wherein each arch-shaped iron core plate (20) has at least 3 through holes (23) for positioning.

14. An iron core (1) as claimed in claim 13, wherein each arch-shaped iron core plate (20) has two distal sides (20c), each of which forms an angle of 20° with the centerline of the respective adjacent through hole (23).

15. An iron core (1) as claimed in claim 14, wherein the through holes (23) of each arch-shaped iron core plate (20) are spaced from one another at 40°.

16. An iron core (1) as claimed in claim 15, wherein each welding recess (22) of each arch-shaped iron core plate (20) is aligned with a corresponding through hole (23) along the center line (L) of that through hole (23).

17. An iron core (1) as claimed in claim 15, wherein the abutted junctions (J) of one annular member (10) are staggered 40° from that of another adjacent annular member (10) in proximity layer of the overlapped structure.

18. An iron core (1) as claimed in claim 15, wherein the coil slots (21) of each arch-shaped iron core plate (20) are spaced along the outer diameter edge area (20b) of the respective arch-shaped iron core plate (20).

19. An iron core (1) as claimed in claim 15, wherein the coil slots (21) of each arch-shaped iron core plate (20) are spaced along the inner diameter edge area (20a) of the respective arch-shaped iron core plate (20).

20. An iron core (1) as claimed in claim 11, which is used for one of stator, internal rotor and external rotor.
